(19) United States
(12) Patent Application Publication
(10) Pub. No.: US 2019/0074519 A1
(43) Pub. Date: Mar. 7, 2019

(54) NONAQUEOUS ELECTROLYTE BATTERY AND MEMBER FOR NONAQUEOUS ELECTROLYTE BATTERY

(71) Applicant: Panasonic Intellectual Property Management Co., Ltd., Osaka (JP)

(72) Inventors: TOMOHIRO YAGISHITA, Osaka (JP); TADAYOSHI TAKAHASHI, Osaka (JP); MASAO OOTSUKA, Osaka (JP); KYOUSUKE OKAZAKI, Osaka (JP)

(21) Appl. No.: 15/767,194

(22) PCT Filed: Oct. 7, 2016
(86) PCT No.: PCT/JP2016/004514

§ 371 Date: Apr. 10, 2018

(30) Foreign Application Priority Data
Nov. 13, 2015 (JP) 2015-223361

(51) Int. Cl. H01M 4/66; H01M 2/02; H01M 10/0568; H01M 10/0569; H01M 2/08; H01M 10/052

(52) U.S. Cl. CPC H01M 4/662; H01M 2/022; H01M 10/0568; H01M 10/052; H01M 2/0285; H01M 2/08; H01M 10/0569

(57) ABSTRACT

A nonaqueous electrolyte battery includes a power generation element and a case for accommodating the power generation element. The power generation element includes a positive electrode, a negative electrode, and a nonaqueous electrolyte. At least one selected from a group consisting of the positive electrode, the negative electrode, and the case includes stainless steel containing Sn.

### TECHNICAL FIELD

The present invention relates to a nonaqueous electrolyte battery in which at least one of a positive electrode, a negative electrode, and a case includes stainless steel.

### BACKGROUND ART

Nonaqueous electrolyte batteries are used for many electronic apparatuses because the batteries have a high voltage, a high energy density, and a low self-discharge. For example, lithium batteries have an extremely long storage life, and can be stored in a long term of 10 years or more at a normal temperature. Therefore, the lithium batteries are widely used as main power sources of various meters and memory backup power sources.

Generally, a nonaqueous electrolyte included in a nonaqueous electrolyte battery has a nature to corrode a metal easily. Therefore, as a component that contacts with the nonaqueous electrolyte, stainless steel having a high corrosion resistance is generally employed. The corrosion resistance of the stainless steel, as defined by JIS standard, is evaluated as a corrosion resistance to an acidic aqueous solution or an aqueous solution of chloride. Especially regarding the corrosion resistance to the aqueous solution of chloride, a pitting index shown by the following formula is used as the indicator:

Pitting index=Cr content+3.3 Mo content+20 N content (content: mass %).

Generally, this indicator is used also for evaluating the corrosion resistance to the nonaqueous electrolyte, and stainless steel having a high pitting index is employed (Patent Literature 1). In order to improve the corrosion resistance, it is suggested that the Cr content in a passivation film on the surface of stainless steel will be increased by a special surface treatment (Patent Literature 2).

### CITATION LIST

### Patent Literature

PTL 1: Unexamined Japanese Patent Publication No. 2006-164527

PTL 2: Unexamined Japanese Patent Publication No. 2015-86470

### SUMMARY OF THE INVENTION

However, stainless steel having a high pitting index, contains a large amount of expensive Cr or Mo. The surface treatment of the stainless steel also increases the manufacturing cost. The excessive price competition of a nonaqueous electrolyte battery results in increasing importance as for reducing the cost of components in a nonaqueous electrolyte battery.

In consideration of the above-mentioned problems, the present disclosure relates to a nonaqueous electrolyte battery including a power generation element and a case for accommodating the power generation element. The power generation element includes a positive electrode, a negative electrode, and a nonaqueous electrolyte. At least, one selected from a group consisting of the positive electrode, the negative electrode, and the case includes stainless steel containing Sn. The present disclosure also relates to a component for a nonaqueous electrolyte battery that includes stainless steel containing Sn.

In the present disclosure, the content of expensive Cr or Mo in stainless steel can be reduced, and the stainless steel does not need a special surface treatment. Therefore, a nonaqueous electrolyte battery having a high storage characteristic can be provided at a low cost.

### BRIEF DESCRIPTION OF DRAWINGS

FIG. 1 is a front cut-away section view of a cylindrical nonaqueous electrolyte battery in accordance with an exemplary embodiment of the present invention.

FIG. 2 is a vertical sectional view of a coin-type nonaqueous electrolyte battery in accordance with another exemplary embodiment of the present invention.

FIG. 3 is a diagram showing the relationship between the pitting index of stainless steel and the corrosion voltage to a NaCl aqueous solution.

FIG. 4 is a diagram showing the relationship between the pitting index of stainless steel and the corrosion voltage to a nonaqueous electrolyte.

FIG. 5 is a diagram showing the relationship between the pitting index of stainless steel and the corrosion voltage to another nonaqueous electrolyte.

### DESCRIPTION OF EMBODIMENTS

A nonaqueous electrolyte battery related to the present invention includes a power generation element and a case for accommodating the power generation element. The power generation element includes a positive electrode, a negative electrode, and a nonaqueous electrolyte. Here, at least one selected from a group consisting of the positive electrode, the negative electrode, and the case includes stainless steel containing Sn.

The positive electrode, the negative electrode, and the case are always in contact with the nonaqueous electrolyte, so that the stainless steel included in them needs to have a corrosion resistance to the nonaqueous electrolyte.

When Sn is added to the stainless steel, the corrosion resistance to the nonaqueous electrolyte is remarkably improved. At this time, the degree of improvement in the corrosion resistance is larger than that to an aqueous solution. When an aqueous solution is used, a passivation oxide film is produced on the stainless steel. When a nonaqueous electrolyte is used, a compound film is considered to be produced through a reaction with the nonaqueous electrolyte. In this case, the corrosion resistance of a compound containing Sn is high, so that the corrosion resistance of the stainless steel is considered to be remarkably improved. Therefore, the additive amount of Cr or Mo can be reduced, and hence a cheap stainless steel can be employed. Furthermore, addition of Sn decreases the electric resistance of the material, so that an effect of reducing the internal resistance of the battery and improving the discharge characteristic can be expected.

The shape and material of the case for accommodating the power generation element are not particularly limited. However, the case made of the stainless steel generally includes a battery can, and a sealing plate for blocking the opening in the battery can. The shape of such a case is a cylindrical shape, coin shape (or button shape), or prismatic shape. In this structure, it is desired that at least one of the battery can and sealing plate includes stainless steel containing Sn. At this time, when the stainless steel containing Sn forms at least a part of the battery can and/or sealing plate, a suitable effect of improving the corrosion resistance can be produced. However, preferably, the stainless steel containing Sn forms at least the inner surface of the battery can and/or sealing plate contacted with the nonaqueous electrolyte.

When the positive electrode includes a positive electrode active material and a positive electrode current collector electrically connected to the positive electrode active material, the positive electrode current collector may include stainless steel containing Sn. Furthermore, when the negative electrode includes a negative electrode active material and a negative electrode current collector electrically connected to the negative electrode active material, the negative electrode current collector may include stainless steel containing Sn.

Additionally, when there is the other metal component contacted with the nonaqueous electrolyte in the nonaqueous electrolyte battery expect for the collector and the can, stainless steel containing Sn may be used for the metal component.

From the viewpoint of improving the corrosion resistance, it is preferable that the Cr content in the stainless steel containing Sn is high, and is 13 mass % or more preferably. In consideration of the price, the Cr content is preferably 25 mass % or less, more preferably 20 mass % or less. Generally, it is preferable that the stainless steel used as a component for the nonaqueous electrolyte battery contains Cr by higher than 25 mass %. However, the stainless steel containing Sn can keep a high corrosion resistance to the nonaqueous electrolyte even when the Cr content is reduced to 25 mass % or less. Even so, stainless steel that contains Sn and has a high Cr content (or pitting index) may be employed. In this case, the corrosion resistance to the nonaqueous electrolyte is remarkably improved. Also, Stainless steel having a high Cr content generally has a low workability. However, as the strength of stainless steel is slightly reduced by the addition of Sn because of the strength of Sn lower than that of Fe or Cr, the effect of improving the workability can be expected in adding even a small amount of Sn.

From the viewpoint of improving the long-term storage characteristic, it is preferable that the stainless steel containing Sn is used for a nonaqueous electrolyte battery whose battery voltage is 4.0 V or less, furthermore, 3.8 V or less. Here, when Sn is added to the stainless steel, and Cr content in the stainless steel is increased in order to increase the pitting index, the corrosion resistance is remarkably improved. Therefore, the stainless steel that contains Sn and has a high Cr content can be appropriately applied also to a nonaqueous electrolyte battery whose battery voltage exceeds 4.0 V. Here, in a primary battery, the battery voltage is a voltage between the terminals of the positive electrode and negative electrode. In a secondary battery, the battery voltage is a nominal voltage, but it is preferable that the end-of-charge voltage (charge upper-limit voltage) is also restricted to the above-mentioned value.

The Sn content in the stainless steel is not particularly limited as long as the inherent property of the stainless steel can be kept. In other words, the stainless steel contains Fe by 50 mass % or more, Cr by 10.5 mass % or more, and Sn by any content. When the Sn content in the stainless steel is excessively high, however, the strength of the component for the battery is apt to decrease. The Sn content in the stainless steel is preferably 0.5 mass % or less, more preferably 0.3 mass % or less, further preferably 0.25 mass % or less.

The Sn contained in the stainless steel—even when the Sn content is low—produces the effect corresponding to the Sn content. From the viewpoint of sufficiently improving the corrosion resistance to the nonaqueous electrolyte, however, the Sn content in the stainless steel is preferably 0.05 mass % or more, more preferably 0.1 mass % or more.

The type of the stainless steel as a base material adding Sn is not particularly limited, but a ferritic, austenitic, martensitic, or austenitic/ferritic stainless steel can be employed particularly without limitation.

The nonaqueous electrolyte includes a lithium salt as a solute, and a nonaqueous solvent to dissolve the lithium salt. From the viewpoint of improving the lithium-ion conductivity, it is preferable that the nonaqueous solvent contains at least dimethoxyethane. Especially, in a nonaqueous electrolyte battery whose battery voltage is 4.0 V or less, using dimethoxyethane as the main component of the nonaqueous solvent allows both a high discharge performance and a high storage characteristic. At this time, the storage characteristic is remarkably improved when stainless steel containing Sn is used for the case, for example.

Preferably, the lithium salt contains at least one selected from a group consisting of lithium perchlorate (LiClO₄), lithium tetrafluoroborate (LiBF₄), bisfluorosulfonylimide lithium (LiN(SO₂F)₂), and bistrifluoromethylsulfonylimide lithium (LiN(SO₂CF₃)₂). Using these lithium salts can enhance the effect of suppressing the corrosion of the stainless steel containing Sn.

The nonaqueous electrolyte battery of the present invention may be a primary battery or may be a secondary battery. A representative example of the primary battery includes a lithium battery having a cylindrical shape or coin shape. A representative example of the secondary battery includes a lithium-ion battery having a cylindrical shape, prismatic shape, or coin shape.

Next, specific exemplary embodiments of the present invention are described. However, the following exemplary embodiments are only a part of the specific examples of the present invention, and do not limit the technological scope of the present invention.

### First Exemplary Embodiment

The present exemplary embodiment describes a cylindrical lithium battery.

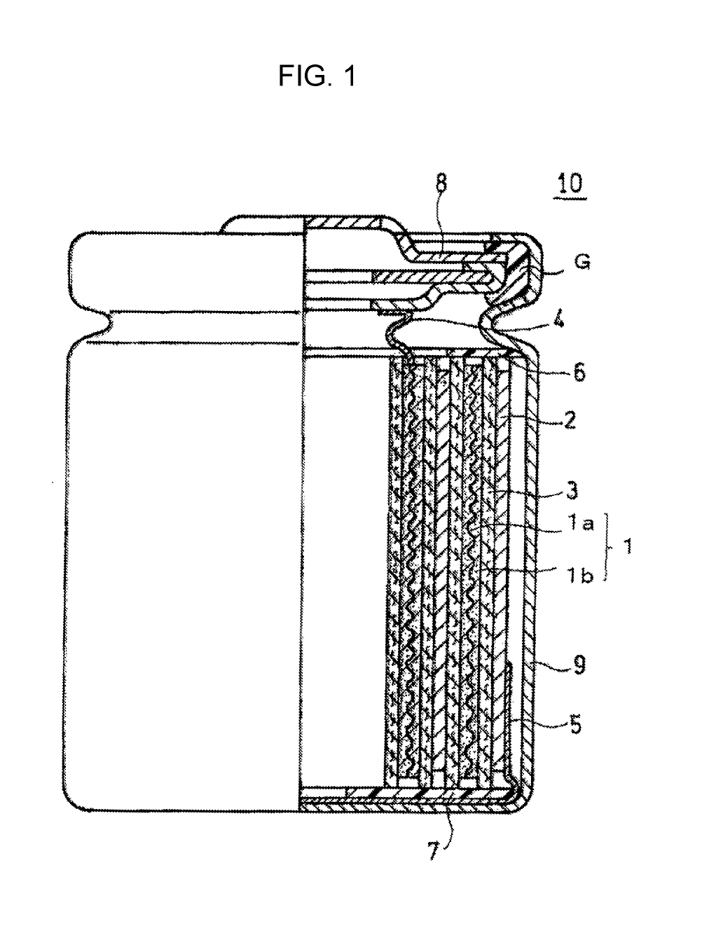

FIG. 1 shows a front and partially cutaway section view of a cylindrical lithium battery in accordance with an exemplary embodiment of the present invention. Lithium battery 10 includes belt-like positive electrode 1 and belt-like negative electrode 2. Positive electrode 1 and negative electrode 2 are spirally wound via separator 3, thereby producing a cylinder shape electrode assembly. The electrode assembly and a nonaqueous electrolyte (not shown) are stored inside battery can 9 having an opening and a bottom, and the opening is sealed with plate 8 via gasket G. Sealing plate 8 and battery can 9 constitute a case of the lithium battery. Upper insulating plate 6 and lower insulating plate 7 for internal short circuit protection are disposed in an upper part and lower part of the electrode assembly, respectively.

(Positive Electrode)

Positive electrode 1 includes positive electrode current collector 1a, and positive electrode mixture 1b containing a positive electrode active material. Positive electrode mixture 1b is coated with each of both surfaces of sheet-like positive electrode current collector 1a to bury the current collector, for example. As the positive electrode active material, graphite fluoride, manganese dioxide, or vanadium pentoxide is employed. These positive electrode active materials have a potential less than 4.0 V versus lithium. The positive electrode mixture may include a resin material as a binder. Positive electrode mixture 1b may be included as a conductive agent. As the conductive agent, preferably, graphite powder such as artificial graphite or natural graphite, or carbon black such as acetylene black or Ketjen black is employed. It is preferable to employ a mixture of the graphite powder and carbon black. There is an exposed portion of positive electrode current collector in positive electrode 1, and one end of positive electrode lead 4 is welded to the portion. The other end of positive electrode lead 4 is welded to the inner surface of sealing plate 8.

Stainless steel can be used for positive electrode current collector 1a, sealing plate 8, and battery can 9. For example, positive electrode current collector 1a may include an expanded metal, net, or punching metal made of stainless steel. In a high-temperature region of 60° C. or more, the corrosion potential decreases, and the corrosion is easily occurred. Therefore, from the viewpoint of providing a lithium battery having an excellent high-temperature storage characteristic, it is preferable to employ stainless steel containing Sn as a material of positive electrode current collector 1a.

(Negative Electrode)

As negative electrode 2, metal lithium or a lithium alloy can be employed. As the lithium alloy, Li—Al, Li—Sn, Li—NiSi, or Li—Pb is preferable. Each of these materials can be used as a negative electrode after it is formed in a sheet shape. Among these lithium alloys, a Li—Al alloy is preferable. Preferably, the content of other metal elements expect for lithium in the lithium alloy is 0.2 to 15 mass %, from the viewpoint of keeping the discharge capacity or stabilizing the internal resistance. Alternatively, negative electrode 2 may include: a negative electrode mixture including a negative electrode active material; and a negative electrode current collector to which the negative electrode mixture adheres. The type of the negative electrode active material is not particularly limited. However, examples of the negative electrode active material include: a carbon material such as natural graphite, artificial graphite, or non-graphitizable carbon; a metal oxide such as silicon oxide, zinc oxide, niobium pentoxide, or molybdenum dioxide; and lithium titanate. The negative electrode mixture may include a binder made of a resin material, or may include a conductive agent. Negative electrode 2 is connected to one end of negative electrode lead 5. The other end of negative electrode lead 5 is welded to the inner surface of battery can 9.

(Separator)

A separator is disposed between the positive electrode and the negative electrode. As the separator, a porous sheet made of an insulating material is employed. Specifically, a nonwoven fabric made of a synthetic resin, or a microporous film made of a synthetic resin is employed. As the synthetic resin used for the nonwoven fabric, polypropylene, polyphenylene sulfide, or polybutylene terephthalate is employed, for example. As the synthetic resin used for the microporous film, polyethylene or polypropylene is employed, for example.

(Nonaqueous Electrolyte)

A nonaqueous electrolyte includes a lithium salt and a nonaqueous solvent to dissolve the lithium salt.

The nonaqueous solvent may be any organic solvent generally available for a lithium battery, and is not particularly limited. Examples of the nonaqueous solvent include γ-butyrolactone, γ-valerolactone, propylene carbonate, ethylene carbonate, and 1, 2-dimethoxyethane. Among them, it is desirable that the nonaqueous solvent includes at least dimethoxyethane.

Examples of the lithium salt include lithium tetrafluoroborate, hexafluorophosphate, lithium trifluoromethanesulfonate, lithium perchlorate, bisfluorosulfonylimide lithium, and bistrifluoromethylsulfonylimide lithium. Among them, it is desirable that the lithium salt includes at least one selected from a group consisting of lithium perchlorate, lithium tetrafluoroborate, bisfluorosulfonylimide lithium, and bistrifluoromethylsulfonylimide lithium.

(Case)

The case for accommodating the power generation element includes: battery can 9 having an opening and a bottom; and sealing plate 8 for blocking the opening in battery can 9. Both battery can 9 and sealing plate 8 may be made of typical stainless steel. From the viewpoint of providing a lithium battery having an excellent high-temperature storage characteristic, however, it is desirable to employ stainless steel containing Sn. Regarding the battery in the shown example, a noble potential is applied to sealing plate 8, so that it is desirable that at least sealing plate 8 is made of stainless steel containing Sn. Furthermore, the following composition may be employed: the battery can is made of stainless steel that contains Sn and has a pitting index less than 20 or less than 16, and the sealing plate is made of stainless steel that contains Sn and has a pitting index of 20 or more.

### Second Exemplary Embodiment

The present exemplary embodiment describes a coin-type lithium battery.

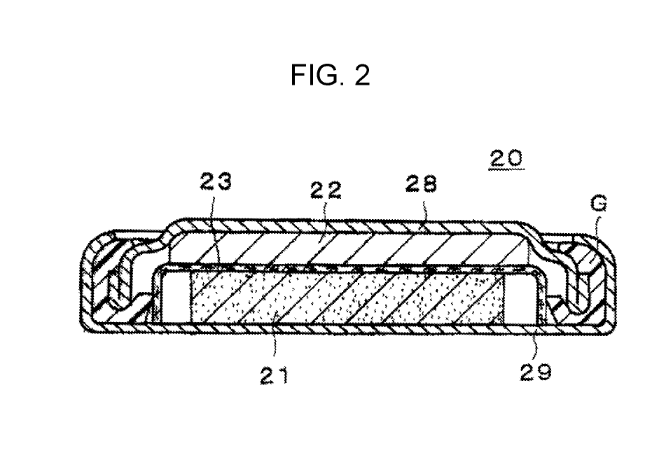

FIG. 2 shows a vertical sectional view of a coin-type lithium battery in accordance with an exemplary embodiment of the present invention. Coin-type lithium battery 20 includes: coin-type positive electrode 21 accommodated in shallow battery can 29; and coin-type negative electrode 22 attached on sealing plate 28 for blocking the opening in battery can 29. Positive electrode 21 and negative electrode 22 are disposed so as to face each other via separator 23. Gasket G is disposed at a rim of sealing plate 28, and the opening end of battery can 29 and gasket G are caulked. Positive electrode 21 and separator 23 are impregnated with a nonaqueous electrolyte (not shown).

Coin-type positive electrode 21 can be produced by pressure-molding the positive electrode mixture into a coin-type pellet shape. Negative electrode 22 can be produced by punching a lithium metal or lithium alloy in a coin shape. Alternatively, coin-type negative electrode 22 may be produced by pressure-molding the negative electrode mixture into a coin-type pellet shape.

Also in this structure, the case for accommodating the power generation element includes battery can 29 and sealing plate 28 for blocking the opening in battery can 29. Both battery can 29 and sealing plate 28 may be made of typical stainless steel. From the viewpoint of providing a lithium battery having an excellent high-temperature storage characteristic, however, it is desirable to employ stainless steel containing Sn.

Thus, cylindrical and coin-type lithium batteries (especially, primary batteries) have been described. However, the present invention may be applied to a secondary battery such as a lithium-ion battery, or may be applied to another nonaqueous electrolyte battery.

Next, the present invention is described more specifically on the basis of examples. However, the following examples do not limit the present invention.

### Examples 1 to 2 and Comparative Examples 1 to 2

As samples of a component for a nonaqueous electrolyte battery, stainless steel foils (size: 10 mm×40 mm, and thickness: 0.2 mm) having the compositions and pitting indices shown in Table 1 are prepared. In order to make the final exposed surface 10 mm×10 mm, the residual surface is insulated using polypropylene-made tape. Sn-SUS-1 is a sample of example 1, Sn-SUS-2 is that of example 2, SUS430 is that of comparative example 1, and SUS444 is that of comparative example 2. The pitting indices of the samples are calculated from the following formula.

Pitting index=Cr content+3.3 Mo content+20 N content (content: mass %)

TABLE 1

| Type of steel | Sn-SUS-1 | Sn-SUS-2 | SUS430 | SUS444 |
|---|---|---|---|---|
| Cr(mass %) | 14.2 | 17.1 | 16.2 | 18.7 |
| Mo(mass %) | 0 | 0 | 0 | 1.8 |
| N(mass %) | 0.011 | 0.013 | 0 | 0.009 |
| Sn(mass %) | 0.13 | 0.18 | 0 | 0 |
| Pitting index | 14 | 17 | 16 | 25 |
| Corrosion voltage A(V) | 0.058 | 0.303 | 0.228 | 0.543 |
| Corrosion voltage B(V) | 4.822 | 4.918 | 4.551 | 4.955 |
| Corrosion voltage C(V) | 4.186 | 4.535 | 3.900 | 4.721 |

[Evaluation 1]

Each sample is used as a working electrode and is immersed in a NaCl aqueous solution (NaCl concentration: 0.154 mol/L), and an Au plate as a counter electrode is immersed in it, a voltage is applied between the electrodes, and a response current is measured. Corrosion voltage A in Table 1 shows the applied voltage when the response current is 10 μA/cm².

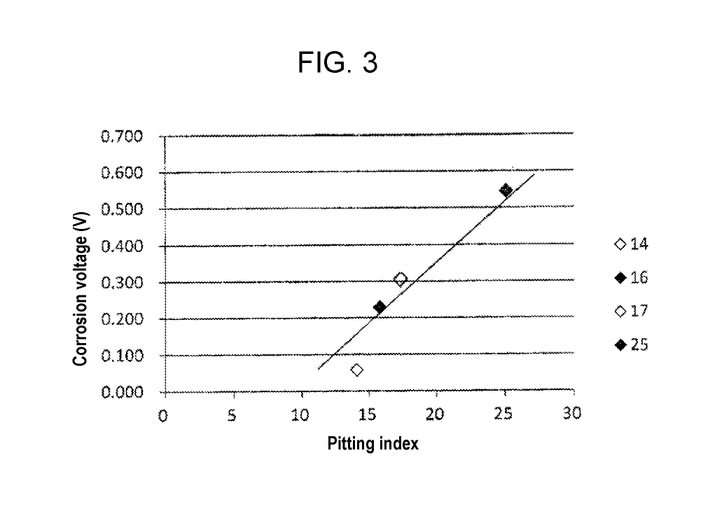

FIG. 3 shows the relationship between the pitting index and the corrosion voltage.

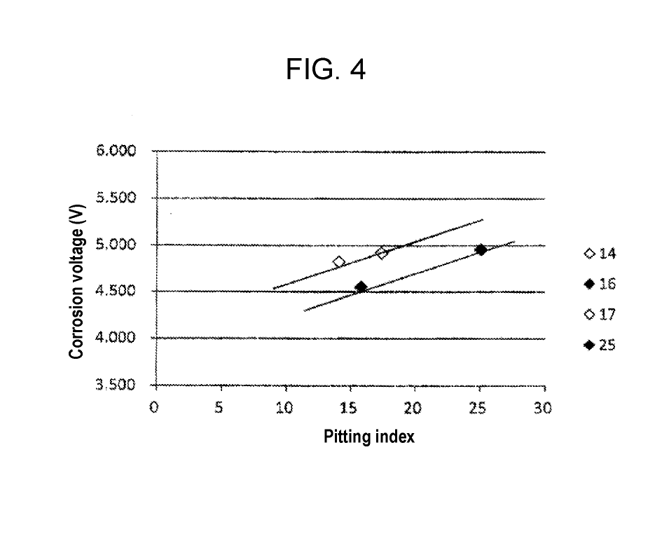

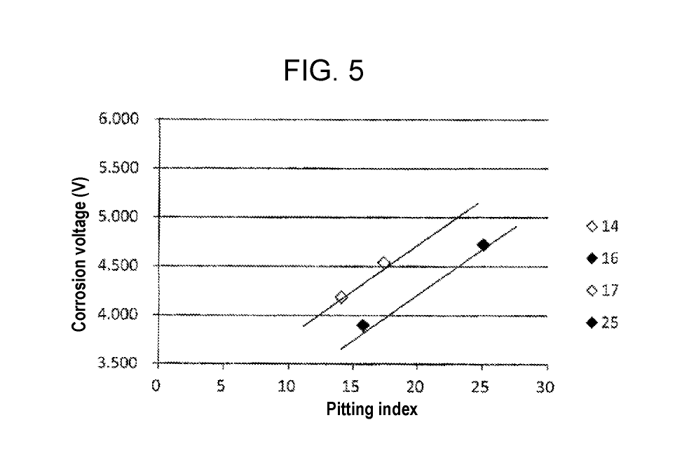

Symbols ⋄ show a plot of stainless steel containing Sn (Sn-SUS), and symbols ♦ show a plot of stainless steel containing no Sn (SUS). As below, it is the same manner for FIG. 4 and FIG. 5

According to FIG. 3, the following property can be understood: regardless of the presence or absence of Sn, stainless steel has a corrosion resistance substantially corresponding to the pitting index in the NaCl aqueous solution.

[Evaluation 2]

Nonaqueous electrolyte B is prepared by dissolving LiClO₄ at a concentration of 0.8 mol/L in a mixture (nonaqueous solvent) of propylene carbonate (PC) and dimethoxyethane (DME) at a volume ratio of 1:1.

Each sample is used as a working electrode and is immersed in nonaqueous electrolyte B, and an Li plate as a counter electrode is immersed in it, a voltage is applied between the electrodes, and a response current is measured. Corrosion voltage B in Table 1 shows the applied voltage when the response current is 10 μA/cm². FIG. 4 shows the relationship between the pitting index and the corrosion voltage.

According to FIG. 4, the following property can be understood: in the nonaqueous electrolyte, the corrosion resistance of stainless steel containing Sn shows a behavior that deviates from one predicted from the pitting index. Differently from the behavior in the NaCl aqueous solution, the plot points of Sn-SUS exist on the upside of the line that interconnects the plot points of SUS, namely in a region indicating a higher corrosion resistance.

[Evaluation 3]

Nonaqueous electrolyte C is prepared by dissolving LiBF₄ at a concentration of 1.0 mol/L in a mixture (nonaqueous solvent) of propylene carbonate (PC) and dimethoxyethane (DME) at a volume ratio of 1:1.

Each sample is used as a working electrode and is immersed in nonaqueous electrolyte C, and an Li plate as a counter electrode is immersed in it, a voltage is applied between the electrodes, and a response current is measured. Corrosion voltage C in Table 1 shows the applied voltage when the response current is 10 μA/cm². FIG. 5 shows the relationship between the pitting index and the corrosion voltage.

According to FIG. 5, the following property can be understood: also in nonaqueous electrolyte C containing a solute different from that of nonaqueous electrolyte B, the corrosion resistance of stainless steel containing Sn shows a behavior that deviates from one predicted from the pitting index. Also in this example, the plot points of Sn-SUS exist on the upside of the line that interconnects the plot points of SUS, namely a region indicating a higher corrosion resistance.

### Example 3

(i) Positive Electrode

A wet positive electrode mixture is prepared in the following steps:

mixing 100 pts. mass of graphite fluoride as a positive electrode active material, 10 pts. mass of acetylene black as a conductive material, and 15 pts. mass of polytetrafluoroethylene as a binder; and

adding pure water and a surface-active agent to the obtained mixture, and kneading them.

Next, the wet positive electrode mixture and positive electrode current collector 1a, which of thickness is 0.2 mm and is expanded metal made of a Sn-SUS-1, are passed between a pair of rotating rollers rotating at a constant speed, thereby filling the positive electrode mixture into pores in the expanded metal. At this time, both surfaces of the expanded metal are coated with positive-electrode mixture layers, thereby producing an electrode plate precursor. Then, the electrode plate precursor is dried, is rolled by roll press until the thickness becomes 0.3 mm, is cut in a predetermined size (width: 19 mm, and length: 175 mm), thereby producing positive electrode 1. The positive electrode mixture is peeled from a part of positive electrode 1 to expose the positive electrode current collector, and positive electrode lead 4 is welded to the exposed part.

(ii) Negative Electrode

A metal lithium plate of a thickness of 0.20 mm is cut in a predetermined size (width: 17 mm and length: 195 mm), thereby producing negative electrode 2. Negative electrode lead 5 is connected to negative electrode 2.

(iii) Electrode Assembly

A polypropylene-made nonwoven fabric of a thickness of 25 μm is interposed as separator 3 between positive electrode 1 and positive electrode 2, and they are spirally wound, thereby producing a cylinder shape electrode assembly.

(iv) Nonaqueous Electrolyte

A nonaqueous electrolyte is prepared by dissolving LiBF₄ as a lithium salt at a concentration of 1 mol/L in a mixture (nonaqueous solvent) of PC and DME at a volume ratio of 1:1.

(v) Assembling Cylindrical Battery

The obtained electrode assembly is inserted into a Sn-SUS-1 made cylindrical battery can 9 having bottom with disposing ring-like lower insulating plate 7 on the bottom of the electrode assembly. Then, positive electrode lead 4 connected to positive electrode current collector 1a of positive electrode 1 is joined to the inner surface of sealing plate 8 made of Sn-SUS-1, and negative electrode lead 5 connected to negative electrode 2 is joined to the inner bottom surface of battery can 9.

Then, the nonaqueous electrolyte is poured into battery can 9, upper insulating plate 6 is disposed on the electrode assembly, then the opening in battery can 9 is sealed by sealing plate 8. Thus, a cylindrical lithium battery (battery A1) of ⅔A size shown in FIG. 1 is completed.

### Example 4

Stainless steel foil Sn-SUS-3 having the composition shown in Table 2 is prepared. A lithium battery (battery A2) is produced similarly to battery A1 except that stainless steel made of Sn-SUS-3 is used as the positive electrode current collector, battery can, and sealing plate.

### Example 5

Stainless steel foil Sn-SUS-4 having the composition shown in Table 2 is prepared. A lithium battery (battery A3) is produced similarly to battery A1 except that stainless steel made of Sn-SUS-4 is used as the positive electrode current collector, battery can, and sealing plate.

### Comparative Example 3

A lithium battery (battery B) is produced similarly to battery A1 except that stainless steel containing no Sn (SUS430) is used as the positive electrode current collector, battery can, and sealing plate.

The internal resistances of batteries A1 to A3 and B produced in the above-mentioned manner are measured in the initial state and after storage for one month at 85° C. The internal resistances are measured by a sine-wave alternating-current method of 1 kHz. The test result is summarized in Table 2.

TABLE 2

| | Battery | | | |
|---|---|---|---|---|
| | A 1 | A 2 | A 3 | B |
| Type of steel | Sn-SUS-1 | Sn-SUS-3 | Sn-SUS-4 | SUS430 |
| Cr(mass %) | 14.2 | 13.9 | 14.5 | 16.2 |
| Mo(mass %) | 0 | 0 | 0 | 0 |
| N(mass %) | 0.011 | 0.013 | 0.010 | 0 |
| Sn(mass %) | 0.13 | 0.24 | 0.3 | 0 |
| Initial internal | 0.36 | 0.34 | 0.37 | 0.40 |
| resistance (Ω) | | | | |
| Internal resistance | 0.62 | 0.63 | 0.71 | 1.01 |
| after high-temper- | | | | |
| ature storage(Ω) | | | | |

In battery B in comparative example 3, the internal resistance after storage for one month at 85° C. increases. This is considered that the metal dissolution from the positive electrode current collector in the battery will result in the degradation of the positive electrode current collector.

While, in batteries A1 to A3 of examples 3 to 5, the increase in the internal resistance after storage for one month at 85° C. is slight. Furthermore, as there are difference in the initial internal resistance, it can also be probably expected that adding Sn to stainless steel produces an effect of reducing the electric resistance.

In battery A3 of example 5, the internal resistance after storage for one month at 85° C. is slightly higher than those in batteries A1 and A2. This is considered that slightly reduction of the sealability with reducing the strength of a battery component by addition of Sn will result in a small amount of water of permeation into the battery.

### INDUSTRIAL APPLICABILITY

The present invention can be applied to various nonaqueous electrolyte batteries, but especially it is preferable that the present invention is applied to a lithium battery requiring a storage characteristic and a low cost.

### REFERENCE MARKS IN THE DRAWINGS

1, 21 positive electrode
1a positive electrode current collector
1b positive electrode mixture
2, 22 negative electrode
3, 23 separator
4 positive electrode lead
5 negative electrode lead
6 upper insulating plate
7 lower insulating plate
8, 28 sealing plate
9, 29 battery can
10, 20 lithium battery

1. A nonaqueous electrolyte battery comprising:
a power generation element; and
a case for accommodating the power generation element,
wherein the power generation element includes a positive electrode, a negative electrode, and a nonaqueous electrolyte, and
wherein at least one selected from a group consisting of the positive electrode, the negative electrode, and the case includes stainless steel containing Sn.

2. The nonaqueous electrolyte battery according to claim 1, wherein
the case includes a battery can, and a sealing plate for blocking an opening in the battery can, and
at least one of the battery can and the sealing plate includes the stainless steel.

3. The nonaqueous electrolyte battery according to claim 1, wherein
the positive electrode includes:
a positive electrode active material; and
a positive electrode current collector electrically coupled to the positive electrode active material, and
the positive electrode current collector includes the stainless steel.

4. The nonaqueous electrolyte battery according to claim 1, wherein
the negative electrode includes:
a negative electrode active material; and
a negative electrode current collector electrically coupled to the negative electrode active material, and
the negative electrode current collector includes the stainless steel.

5. The nonaqueous electrolyte battery according to claim 1, wherein
a Cr content in the stainless steel is 13 mass % or more.

6. The nonaqueous electrolyte battery according to claim 1, wherein
a Cr content in the stainless steel is 25 mass % or less.

7. The nonaqueous electrolyte battery according to claim 1, wherein
a Cr content in the stainless steel is 20 mass % or less.

8. The nonaqueous electrolyte battery according to claim 1, wherein
a battery voltage is 4.0 V or less.

9. The nonaqueous electrolyte battery according to claim 1, wherein
a Sn content in the stainless steel is 0.5 mass % or less.

10. The nonaqueous electrolyte battery according to claim 1, wherein
a Sn content in the stainless steel is 0.25 mass % or less.

11. The nonaqueous electrolyte battery according to claim 1, wherein
the nonaqueous electrolyte includes a lithium salt, and a nonaqueous solvent in which the lithium salt is dissolved, and
the nonaqueous solvent contains dimethoxyethane.

12. The nonaqueous electrolyte battery according to claim 1, wherein
the nonaqueous electrolyte includes a lithium salt, and a nonaqueous solvent in which the lithium salt is dissolved, and
the lithium salt contains at least one selected from a group consisting of lithium perchlorate, lithium tetrafluoroborate, bisfluorosulfonyIimide lithium, and bistrifluoromethylsulfonylimide lithium.

13. A member for a nonaqueous electrolyte battery, the member comprising stainless steel containing Sn.
